(19) United States
(12) Patent Application Publication
(10) Pub. No.: US 2022/0136457 A1
(43) Pub. Date: May 5, 2022

(54) CONTROL UNIT, WASTE HEAT RECOVERY SYSTEM, VEHICLE COMPRISING SUCH A SYSTEM, AND METHOD FOR STARTING AN EXPANSION DEVICE OF A WASTE HEAT RECOVERY SYSTEM

(71) Applicant: Scania CV AB, Södertälje (SE)

(72) Inventors: Svante JOHANSSON, Vällingby (SE); Erik HÖCKERDAL, Södertälje (SE); Björn JOHANSSON, Älvsjö (SE)

(73) Assignee: Scania CV AB, Södertälje (SE)

(21) Appl. No.: 17/438,589

(22) PCT Filed: Mar. 17, 2020
(86) PCT No.: PCT/SE2020/050273

§ 371 Date: Sep. 13, 2021

(30) Foreign Application Priority Data
Mar. 20, 2019 (SE) 1950345-7

(51) Int. Cl. F02G 5/02; F01K 13/02; F01K 23/06; F01K 23/10; F01N 5/02

(52) U.S. Cl. CPC F02G 5/02; F01K 13/02; F01K 23/065; F01N 2550/06; F01N 5/02; F01N 2240/02; F01N 2410/00; F01K 23/101

(57) ABSTRACT

The present invention relates to a control unit for a waste heat recovery system, wherein the waste heat recovery system is operated in a first mode of operation after a first condition is fulfilled and the system is operated in a second mode of operation after a second condition is fulfilled. The invention also relates to a method for starting an expansion device in a waste heat recovery system.

### CROSS-REFERENCE TO RELATED APPLICATIONS

This application is a National Stage Patent Application (filed under 35 § U.S.C. 371) of PCT/SE2020/050273, filed Mar. 17, 2020 of the same title, which, in turn claims priority to Swedish Patent Application No. 1950345-7 filed Mar. 20, 2019 of the same title; the contents of each of which are hereby incorporated by reference.

### FIELD OF THE INVENTION

The present invention relates to a waste heat recovery system and to a method for starting an expansion device in a waste heat recovery system by controlling a mass flow of working medium in response to fulfillment of a first condition and a second condition. Furthermore, the invention relates to a vehicle comprising a waste heat recovery system.

### BACKGROUND

Vehicle manufacturers are today striving to increase engine efficiency and reduce fuel consumption. This is specifically an issue for manufacturers of heavy vehicles, such as trucks and buses. One way of improving engine efficiency and fuel consumption is waste heat recovery. In vehicles with internal combustion engines, some of the energy from the fuel is dissipated as heat through the exhaust pipes and the engine cooling system. By the use of a waste heat recovery system, the heat from the exhaust gases may instead be used to heat various vehicle components or to produce mechanical work or electricity. Such mechanical work may for example be transferred to the drivetrain or crankshaft and thus be used to help to propel the vehicle. A waste heat recovery system may also recover heat from other heat sources in the vehicle, such as EGR gases, cooling fluids, or fuel cells.

A waste heat recovery system typically comprises a circuit in which a working medium is circulated. The circuit comprises a heat exchanger, an expansion device, a condenser and a working medium conveyor. Before entering the heat exchanger, the working medium is in a liquid state. The heat exchanger is configured to evaporate the working medium such as to create a superheated steam. To achieve this, the heat exchanger transfers heat between a heat source, such as exhaust gases from the internal combustion engine, and the working medium. The superheated steam generated by the heat exchanger then passes into the expansion device wherein it is expanded. By means of the expansion device, the recovered heat may be converted into mechanical work or electricity. By way of example, the expansion device may be mechanically connected to the powertrain using a dutch or a freewheel. The working medium is thereafter cooled in the condenser such that the working medium is reverted to a liquid state. The condenser may typically be connected to a cooling system, which in turn may be a part of the engine cooling system or be a separate cooling system. The conveyor, which may typically be a pump, is configured to control the mass flow of the working medium in the circuit, for example by pressurizing the working medium. The waste heat recovery system may thus be based on for example a Rankine cycle. The waste heat recovery system may further comprise a reservoir for storing the working medium and ensure that there is sufficient working medium available in the circuit at all times.

When the waste heat recovery system is started, the working medium is in a liquid state throughout the circuit and the heat exchanger is cold, When the heat exchanger is heated and the working medium is circulated, operation of the system is commenced but starting the expansion device generally requires particular measures to ensure efficient operation and avoid damage to the expansion device. If the working medium is still in liquid form when it reaches the expansion device or if it condenses because the expansion device has not yet reached a suitable working temperature, the pistons are hindered from moving as intended and they may even be damaged when trying to compress working medium that is in the liquid state.

There is therefore a need for a waste heat recovery system or a method for starting an expansion device in a waste heat recovery system that alleviates the problems described above.

### SUMMARY OF THE INVENTION

The object of the present invention is to eliminate or at least to minimize the problems mentioned above. This is achieved through a control unit for a waste heat recovery system, a waste heat recovery system comprising such a control unit, a method for starting an expansion device in a waste heat recovery system, and a vehicle comprising such a control unit or a waste heat recovery system.

It would thus be advantageous to achieve a waste heat recovery system and method for starting an expansion device overcoming, or at least alleviating, at least some of the above mentioned drawback(s). In particular, it would be desirable to enable a waste heat recovery system and method for starting an expansion device that are configured to detect fulfillment of a first and second condition and operate the system in a first and second mode of operation in response to fulfillment of the conditions to achieve an improved start of the expansion device and to avoid or at least minimize the risk of damage to the expansion device, or other parts in the circuit during start of the waste heat recovery system. To better address one or more of these concerns, a method, control unit and waste heat recovery system having the features defined in the independent claims are provided.

Known prior art solutions may involve allowing the working medium to bypass the expansion device until a sufficient temperature is reached or to introduce a mechanical movement or vibration (sometimes referred to as a kick) that abruptly forces the pistons to start moving. However, such solutions are not able to provide an efficient starting procedure that avoids the risk of damaging the pistons since there are no provisions to prevent the working medium from returning to liquid form in the expansion device when the temperature inside the expansion device is too low. In some solutions, the working medium bypasses the expansion device until it can be heated by the heat exchanger to form a superheated steam that has a sufficiently high temperature to avoid condensation inside the expansion device even if the temperature of the expansion device is low. A too high temperature of the working medium may however risk damaging other constituent components of the waste heat recovery system, such as sealings or the like. This can in worst case scenario lead to leakage of the working medium from the waste heat recovery system.

Therefore, the method for starting an expansion device of a waste heat recovery system in a motor vehicle may comprise circulating a working medium in the waste heat recovery system in response to a first condition being fulfilled, wherein the working medium is at a first mass flow downstream of the heat exchanger and wherein the working medium is circulated through a bypass conduit in the expansion device, in response to a second condition being fulfilled changing the mass flow of the working medium to a second mass flow downstream of the heat exchanger and redirecting the working medium from the bypass conduit to pass through the expansion device for starting the expansion device, wherein the second mass flow is lower than the first mass flow.

Thereby, the start of the expansion device can be performed in a first mode of operation in which the working medium is allowed to flow through a bypass conduit in the expansion device to avoid inserting liquid working medium into the expansion device and at the same time allowing heat from the working medium in the bypass conduit to propagate in at least a part of the expansion device in order to heat the expansion device. In a second mode of operation, the mass flow of working medium is lowered to achieve a superheated steam and the working medium is redirected to flow through the expansion device instead of the bypass conduit. Thereby, the expansion device is already heated when the working medium reaches a piston of the expansion device and the superheated steam is able to start a movement of the piston without condensing to the liquid form.

The first condition may suitably be a start of a combustion engine of the motor vehicle. Thereby, the method for starting the expansion device is initiated as soon as the heat exchanger may be able to provide heat for the working medium so that the expansion device may be in operation as soon as possible after vehicle start.

Optionally, the first condition may suitably be a heat exchanger temperature, such as a temperature of the heating medium in the heat exchanger or a temperature of the heating medium upstream of the heat exchanger. Thereby, the heat exchanger may be heated by exhaust gas or other heat sources until a suitable temperature has been reached so that the start of the expansion device may be performed in a more time-efficient way and the time between fulfillment of the first condition and starting the expansion device is minimized.

The second condition may suitably be an expansion device temperature, such as an expansion device temperature at a downstream end of the expansion device or a temperature of the working medium at the downstream end of the expansion device. Thereby, a change from the first mode of operation to the second mode of operation can take place as soon as the expansion device has reached a suitable temperature. An additional benefit is to be able to avoid damages to temperature sensitive parts of the waste heat recovery system such as sealings and the like by changing to the second mode of operation before the temperature of the working medium is high enough to damage such temperature sensitive parts.

Optionally, the second condition may suitably be a time that has passed since fulfillment of the first condition. Thereby, a more cost efficient waste heat recovery system can be achieved since fewer sensors and detectors are required to detect fulfillment of the first and second conditions. Instead, a suitable time can be selected depending on known information regarding a rate of increase in temperature of the expansion device when subjected to a heated working medium or alternatively depending on other information regarding at least one component in the waste heat recovery system. A time required for heating the expansion device to a suitable temperature can thereby be given as input to the waste heat recovery system and be used as the second condition as outlined above.

The mass flow of the working medium may suitably be changed from the first mass flow to the second mass flow by decreasing a supply of heating medium to the heat exchanger and maintaining a temperature of the working medium in the heat exchanger or downstream of the heat exchanger at a predetermined first temperature by decreasing the mass flow of the working medium. Thereby, the mass flow is decreased but since the temperature is kept stable the working medium is transformed from a liquid form to a superheated gas form. This has the advantage of being more time and energy efficient than some prior art solutions and providing a quick change from liquid to superheated gas.

In one example of the invention, a mass flow of the working medium downstream of the heat exchanger and/or a heat exchanger temperature may be detected, wherein said heat exchanger temperature may be a temperature of the working medium in the heat exchanger or downstream of the heat exchanger, and a supply of heating medium to the heat exchanger may be decreased if the detected heat exchanger temperature is above a predetermined preferred heat exchanger temperature and/or if the detected mass flow of the working medium downstream of the heat exchanger is above a predetermined maximum working medium mass flow. Thereby, heating of the working medium can be controlled and limited to avoid too rapid heating and also to avoid damages due to excessive mass flow or temperature of the working medium.

In one embodiment, the method may suitably comprise requesting a change of operation of a combustion engine of the motor vehicle after the second condition is fulfilled, said change of operation may be a gear shift or a stop and start of the combustion engine. Thereby, a kick may additionally be provided to the expansion device to facilitate start of the pistons.

The control unit for a waste heat recovery system according to the invention may comprise the control unit being configured to obtain a signal corresponding to a first condition being fulfilled and to generate at least one signal for operating the working medium conveyor and an expansion device bypass in a first mode of operation, wherein the control unit is further configured to obtain a signal corresponding to fulfillment of a second condition and to generate at least one signal for operating the working medium conveyor and the expansion device bypass in a second mode of operation.

In one embodiment, the at least one signal for operating the working medium conveyor and the expansion device bypass in the first mode of operation comprises a signal for the working medium conveyor to circulate the working medium and to maintain the working medium at a first mass flow downstream of the heat exchanger, and also comprises a signal for the expansion device bypass to direct the working medium through a bypass conduit at the expansion device, and further the at least one signal for operating the working medium conveyor and the expansion device bypass in the second mode of operation comprises a signal for the working medium conveyor to maintain the working medium at a second mass flow downstream of the heat exchanger, wherein the second mass flow is lower than the first mass flow, and also comprises a signal for the expansion device bypass to direct the working medium through the expansion device for starting the expansion device.

In one embodiment, the control unit is further configured to obtain a signal corresponding to a heat exchanger temperature such as a temperature of the working medium in the heat exchanger or downstream of the heat exchanger or a working medium mass flow downstream of the heat exchanger and to generate a signal for operating a heat exchanger bypass control to limit a supply of heating medium if a detected heat exchanger temperature is above a predetermined preferred heat exchanger temperature, or if a detected working medium mass flow is above a predetermined maximum working medium mass flow.

In one embodiment, the control unit is further configured to request a change of operation of a combustion engine after obtaining a signal corresponding to the second condition being fulfilled. Said change of operation may be a gear shift or a stop and start of the combustion engine.

The waste heat recovery system according to the invention may comprise a heat exchanger, an expansion device, a condenser and a working medium conveyor for circulating a working medium in the system, and also comprises a control unit according to the present invention.

Thereby, fulfillment of the first and second conditions may be obtained and the waste heat recovery system may be operated in response to the conditions in a first mode and a second mode in order to start the expansion device in a more efficient and reliable manner as outlined above.

The waste heat recovery system suitably comprises a first sensor for detecting fulfillment of the first condition, the first sensor being operatively connected to the control unit and optionally also comprising a second sensor for detecting fulfillment of the second condition, the second sensor being operatively connected to the control unit.

The working medium conveyor may suitably be configured in the first mode of operation to circulate the working medium and to maintain the working medium at a first mass flow downstream of the heat exchanger.

Furthermore, an expansion device bypass may be configured in the first mode of operation to direct the working medium through a bypass line at the expansion device, and the working medium conveyor may be configured in the second mode of operation to maintain the working medium at a second mass flow downstream of the heat exchanger, wherein the second mass flow is lower than the first mass flow. Also, the expansion device bypass may suitably be configured in the second mode of operation to direct the working medium through the expansion device for starting the expansion device. Thereby, by controlling the mass flow of working medium through the bypass line to heat the expansion device and to decrease the mass flow of working medium in the second mode of operation in order to change from a liquid state to a superheated state, the system can further improve the start of the system.

The expansion device bypass may suitably comprise an expansion device bypass valve for controlling a mass flow of working medium, either into an expansion device bypass line or into at least one piston of the expansion device. Thereby, the mass flow of working medium is controlled in a reliable way so that the mass flow may be directed through the expansion device bypass line or to the pistons.

The first sensor may suitably be configured to detect a start of a combustion engine of the motor vehicle as the first condition. Optionally, the first sensor may be configured to detect a heat exchanger temperature as the first condition, and heat exchanger temperature may be a temperature of the heating medium in the heat exchanger or a temperature of the heating medium upstream of the heat exchanger.

The second sensor may suitably be configured to detect an expansion device temperature such as an expansion device temperature at a downstream end of the expansion device as the second condition, and said expansion device temperature may be a temperature of the working medium at the expansion device or a temperature of the working medium at a downstream end of the expansion device or downstream of the expansion device. Optionally, the second sensor may suitably be configured to detect as a second condition a time that has passed since the first sensor detected the first condition.

The waste heat recovery system may suitably comprise a third sensor for detecting a heat exchanger temperature, such as a temperature of the working medium in the heat exchanger or downstream of the heat exchanger or a working medium mass flow downstream of the heat exchanger, and may also comprise a heat exchanger bypass control for limiting a supply of heating medium to the heat exchanger, wherein the control unit is further configured to obtain a signal from the third sensor corresponding to a temperature or mass flow and to operate the heat exchanger bypass control to limit the supply of heating medium if a detected heat exchanger temperature is above a predetermined preferred heat exchanger temperature, or if a detected working medium mass flow is above a predetermined maximum working medium mass flow. Thereby, the heat provided to the working medium by the heat exchanger can be controlled to keep operation of the waste heat recovery system efficient and also to avoid damage to the system due to excessive mass flow or temperature that could otherwise cause degradation of sensitive components such as sealings or rupture of conduits transporting working medium in the system such that leakage of working medium could occur.

The control unit may further suitably be configured to request a change of operation of a combustion engine of the motor vehicle after obtaining a signal corresponding to fulfillment of the second condition, and said change of operation may be a gear shift or a stop and start of the combustion engine. Thereby a mechanical movement or vibration (sometimes referred to as a kick) is provided that may facilitate the start of the expansion device.

The control unit may also suitably be distributed in the waste heat recovery system, and/or at least one of the first sensor, second sensor or third sensor may be integrated with the control unit and/or with each other. Thereby, the control unit of the waste heat recovery system may be designed as suitable for a particular embodiment and the number of sensors provided may also vary. In some embodiments, it may be advantageous to provide fewer sensors for cost efficiency reasons whereas it would in other embodiments be advantageous to provide a higher degree of control of the operation of the system and therefore to select a larger number of sensors. In some embodiments, additional sensors could also be provided to detect further information regarding a state or an operation of the waste heat recovery system and to communicate with the control unit.

The bypass line at the expansion device may suitably be arranged in such a way that heat is transferred from the working medium in the bypass line to at least a part of the expansion device for heating the expansion device during the first mode of operation. The bypass line may for instance extend through a housing or a wall of the expansion device, but optionally also through another part of the expansion device.

The present invention also relates to a data processing device comprising means for carrying out the method as outlined above, and said data processing device may be a control unit of a waste heat recovery system.

The present invention also relates to a computer program product comprising instructions which, when the program is executed by a computer, cause the computer to carry out the method as outlined above, and to a computer-readable storage medium comprising instructions which, when executed by a computer, cause the computer to carry out the method as outlined above.

The present invention also relates to a motor vehicle comprising a control unit and/or a waste heat recovery system as outlined above.

Many additional benefits and advantages of the invention will become readily apparent to the person skilled in the art in view of the detailed description below.

### DRAWINGS

The invention will now be described in more detail with reference to the appended drawings, wherein

FIG. 1 schematically illustrates a vehicle according to an embodiment of the invention;

FIG. 2 schematically illustrates a control unit for a waste heat recovery system and a waste heat recovery system according to one exemplifying embodiment of the invention;

FIG. 3 schematically illustrates a method for starting an expansion device according to an embodiment of the invention; and

FIG. 4 schematically illustrates interaction of a control unit with other components of the waste heat recovery system according to one exemplifying embodiment of the invention.

### DETAILED DESCRIPTION OF EMBODIMENTS

The invention will be described in more detail below with reference to exemplifying embodiments and the accompanying drawings. The invention is however not limited to the exemplifying embodiments discussed and shown in the drawings, but may be varied within the scope of the appended claims. Furthermore, the drawings shall not be considered drawn to scale as some features may be exaggerated in order to more clearly illustrate the invention or features thereof.

While the control unit and the waste heat recovery system in the following is disclosed in connection with an internal combustion engine of a vehicle, the present invention is not limited to the waste heat recovery system being one in a vehicle. The waste heat recovery system may be a waste heat recovery system of any internal combustion engine, including but not limited to an internal combustion engine of a vehicle, a stationary engine (such as a power generator), power pack or the like.

Moreover, while the waste heat recovery system in the following is disclosed as using exhaust gases from the internal combustion engine as a heat source or heating medium in the heat exchanger, the present invention is not limited to the use of exhaust gases as a heat source. For example, the heating medium may be EGR (Exhaust Gas Recirculation gases) or coolant fluid.

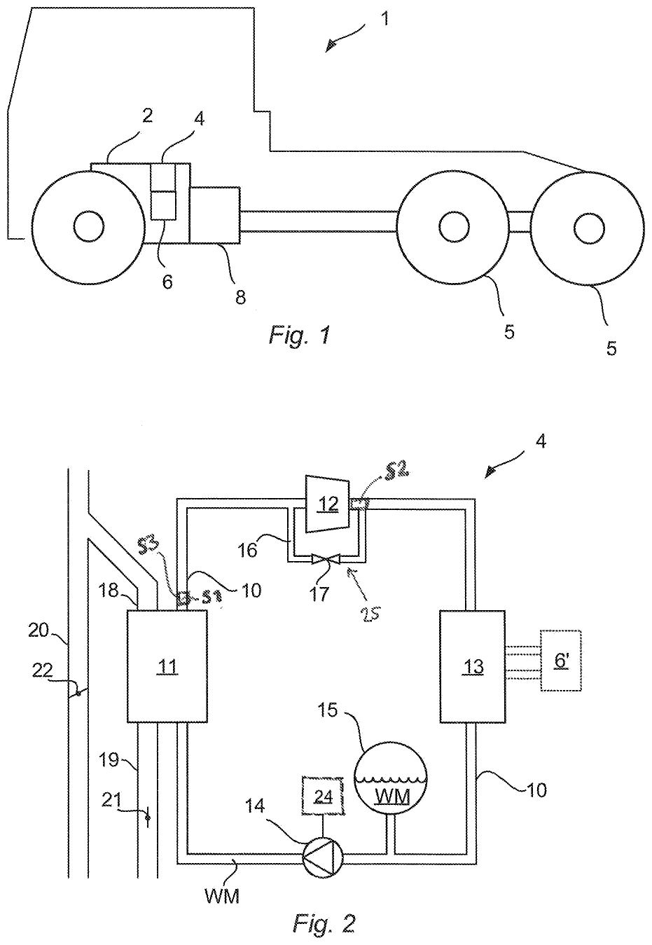

FIG. 1 schematically illustrates a side view of a vehicle 1 comprising an internal combustion engine 2, and a waste heat recovery system 4 associated with the internal combustion engine 2. The vehicle may furthermore comprise a cooling system 6 associated with the internal combustion engine 2 and connected to the waste heat recovery system 4. The vehicle further comprises a gearbox 8 connected to the driving wheels 5 of the vehicle 1. The vehicle 1 may be a heavy vehicle, e.g. a truck or a bus. The vehicle may alternatively be a passenger car. Furthermore, the vehicle may be a hybrid vehicle comprising an electric machine (not shown) in addition to the combustion engine 2. The vehicle may alternatively be a marine vessel, such as a ship.

Waste heat recovery can be accomplished by using heat from for example the exhaust gases to heat a working medium to create steam, i.e. the vaporized working medium arising from heating the working medium. This steam can then be expanded and the produced mechanical work can be used for example to propel the vehicle, generate electricity or drive auxiliary units of the vehicle.

The waste heat recovery system 4 according to a preferred embodiment of the present invention will now be described, first by describing briefly which components may form part of the system 4 along with general operating principles of the system 4 during normal operation. Further below, the inventive system and method for starting the waste heat recovery system 4 will be described in more detail. The control unit 24 according to the invention will be described in connection with the waste heat recovery system 24 but is also a stand-alone unit that can be used in connection with different waste heat recovery systems.

Thus, FIG. 2 schematically illustrates a waste heat recovery system 4 and a control unit 24 according to one exemplifying embodiment of the invention. The waste heat recovery system 4 comprises a circuit 10 in which a working medium WM is circulated. In the circuit, a heat exchanger 11, expansion device 12, condenser 13 and a working medium conveyor 14 are arranged.

Before entering the heat exchanger 11, the working medium is in a liquid state. The heat exchanger 11 is configured to evaporate the working medium such as to create a superheated steam. To achieve this, the heat exchanger 11 transfers heat between a heating medium, such as exhaust gas from the internal combustion engine, and the working medium. The exhaust gas from the internal combustion engine is led to the heat exchanger via a first exhaust gas conduit 18 and exits the heat exchanger via a second exhaust gas conduit 19. Optionally, the exhaust gases from the internal combustion engine may alternatively or partly be led past the heat exchanger 11 via a third exhaust gas conduit 20. To control the amount of exhaust gases passing through the first exhaust gas conduit 18 and the third exhaust gas conduit 20, respectively, the different exhaust gas conduits may suitably comprise one or more valves 21, 22. In FIG. 2, the first valve 21, arranged in the second exhaust gas conduit, is shown in an open position whereas the second valve 22, arranged in the third exhaust conduit 21, is in a closed position. Thus, the exhaust gases would only pass through the heat exchanger 11. It should be noted that the present invention is not limited to the presence of any valves in the exhaust gas conduit or if present, their location within the exhaust gas conduits.

The superheated steam generated by the heat exchanger 11 passes into the expansion device 12 wherein it is expanded. By means of the expansion device 12, the recovered heat may be converted into mechanical work or electricity. By way of example, the expansion device 12 may be mechanically connected to the powertrain of the vehicle using a clutch or a freewheel (not shown). The circuit 10 further comprises an expansion device bypass 25, to enable bypassing the expansion device 12. The expansion device bypass 25 comprises a bypass conduit 16 and a bypass valve 17. During normal operation, the bypass valve 17 is in a closed position and the working medium passes the expansion device 12.

After the working medium has been expanded in the expansion device 12 (or bypassed the expansion device 12), the working medium is cooled in the condenser 13 such that the working medium is reverted to a liquid state. The condenser 13 may typically be connected to a cooling system 6′, which in turn may be a part of the engine cooling system 6 (as shown in FIG. 1) or be a separate cooling system.

The working medium conveyor 14, which may typically be a pump, is configured to control a mass flow of the working medium in the circuit, for example by pressurizing the working medium. In accordance with the present invention, a control unit 24 is arranged in connection with the waste heat recovery system 4 and is configured to receive or obtain signals from sensors that may suitably be arranged in the waste heat recovery system 4 to detect operation parameters or conditions of the waste heat recovery system 4. The control unit 24 is further configured to control operation of the waste heat recovery system 4 in response to detected parameters or to fulfillment of conditions and also in response to other input as will be described in more detail below. Furthermore, the control unit 24 may suitably be configured to control the working medium conveyor 14 and the first and second valves 21, 22 as well as the bypass valve 17 of the expansion device bypass 25. In FIG. 2, the control unit 24 is shown as connected to the working medium conveyor 14, but it is to be understood that the control unit 24 is also operatively connected to at least those parts of the waste heat recovery system 4 that are controlled by the control unit 24, and that in some embodiments the control unit 24 may be operatively connected to other parts of the system as well as to other parts of the vehicle such as the combustion engine.

The expansion device bypass 25 comprises the means for allowing the working medium WM to bypass the expansion device 12. In this embodiment the expansion device bypass 25 comprises the bypass conduit 16 and the bypass valve 17, but other means for directing the flow of working medium WM in a bypass conduit 16 are also possible within the scope of the present invention.

The mass flow of the working medium may in some embodiments be controlled by controlling a mass flow rate through the heat exchanger 11 and/or the condenser 13 and/or the expansion device 12, but in other embodiments it may be sufficient to control the mass flow rate of the working medium conveyor 14.

The waste heat recovery system 4 may further comprise a reservoir 15 for storing the working medium and ensure that there is sufficient working medium available in the circuit 10 at all times.

The working medium of the waste heat recovery system may be any previously known working medium used for this particular purpose. Examples of previously known working mediums include, but are not limited to, water, ethanol and ethanol based mixtures.

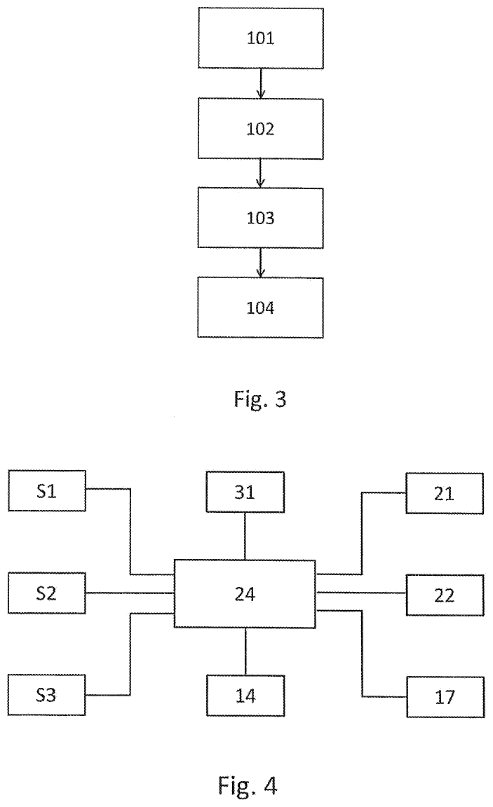

The method for starting the expansion device 12 of a waste heat recovery system 4 according to an embodiment of the invention will now be described with reference to FIG. 3 as well as to FIG. 2.

Starting the waste heat recovery system 4 generally takes place after the waste heat recovery system 4 has been turned off for some time so that each component of the waste heat recovery system 4 has cooled down, often to an ambient temperature. The working medium WM is distributed along the circuit 10 and is in the liquid state due to the lower temperature and to a generally lower pressure in the circuit 10 since the working medium conveyor 14 is not operating to maintain the flow rate in the circuit 10.

When the waste heat recovery system 4 is to be started, a fulfillment of a first condition is detected101 and obtained by the control unit 24 such as by transmission of a signal corresponding to the fulfillment of the first condition from a sensor or the like. The first condition may be a start of the combustion engine of the vehicle or a flow of hot exhaust gas through the heat exchanger 11. This may be determined by detecting a temperature of the exhaust gas that in this embodiment serves as heating medium to the heat exchanger 11. This signifies that the waste heat recovery system 4 can be operated to transfer heat from the heating medium to the working medium WM in the heat exchanger 11.

In response to the first condition being fulfilled, the control unit 24 generates at least one signal that is transmitted to initiate circulation 102 of the working medium WM in the circuit 10. In this embodiment, the circulation is initiated by starting the working medium conveyor 14 so that a mass flow of the working medium WM is generated. At this time, the working medium WM is still in liquid form, but as it passes the heat exchanger 11 it is heated to some extent and thereby transfers heat further along the circuit 10 to the expansion device 12. At the expansion device 12, the working medium WM is directed into the bypass conduit 16 so that introduction of the liquid working medium WM into pistons of the expansion device 12 is avoided. The bypass conduit 16 is in this embodiment arranged at least partly in the expansion device 12 such as in a housing or piston head of the expansion device 12. Thereby, heat from the working medium WM is transferred from the working medium WM to the expansion device 12 when the working medium WM passes through the bypass conduit 16. This prepares the expansion device 12 for operation but does not yet require movement of the pistons and also does not risk causing damage to the pistons by forcing them to move when the working medium WM is still in liquid form.

After passing the expansion device 12, the working medium WM reaches the condenser 13 where it is condensed back to liquid form. The working medium WM is then ready to be circulated through the heat exchanger 11 and bypass conduit 16 of the expansion device 12 again.

In one embodiment, the first condition is a heat exchanger temperature reaching a predetermined value, such as a temperature of the heating medium in the heat exchanger 11 or a temperature of the heating medium upstream of the heat exchanger 11. Thereby, circulation of the working medium WM may be prevented until sufficient heat is supplied to the heat exchanger 11. This enables a quicker and more efficient heating of the expansion device 12, since the working medium WM will transfer a larger amount of heat to the expansion device 12 through walls of the bypass conduit 16 already at a beginning of circulation.

In order to detect the heat exchanger temperature, a first sensor S1 may be provided and may be arranged in the third exhaust gas conduit 20 that serves as a supply channel to the heat exchanger 11, i.e. upstream of the heat exchanger 11 and in contact with the heating medium. Alternatively, the first sensor S1 may be arranged in a downstream end of the heat exchanger 11 and in contact with the working medium WM at that downstream end, but optionally the first sensor S1 may instead be arranged anywhere in the heat exchanger 11 or in a vicinity of the heat exchanger 11 or in the third exhaust gas conduit 20 as shown in FIG. 2. It is preferable to be able to detect the temperature of the heating medium since this gives reliable information of a temperature of the heat exchanger 11 and thereby also of a temperature of the working medium WM that can be expected when it reaches the expansion device 12. In some embodiments it could however instead be desirable to detect the temperature of the heat exchanger 11 itself to determine its state and decide if it has been heated in such a way that it can be expected to reliably heat the working medium WM to a desired temperature. FIG. 2 discloses the first sensor S1 as placed in or adjacent to the third exhaust gas conduit 20, but this is to be understood as an example only.

The term downstream is used herein to denote a portion of the circuit 10 that is reached by the working medium WM after it has passed through a particular part of the circuit. Thus, downstream of the heat exchanger 11 would denote the part of the circuit 10 that is located between the heat exchanger 11 and the expansion device 12 since the working medium WM will pass through this part of the circuit 10 after it has passed through the heat exchanger 11. Also, the term immediately downstream is used herein to denote a segment at a first part of the downstream portion. A temperature of the working medium WM immediately downstream of the heat exchanger 11 is therefore a temperature in a segment of the portion of the circuit 10 located between the heat exchanger 11 and the expansion device 12, said segment being the first part of that portion that the working medium WM reaches after it has passed through the heat exchanger 11.

Similarly, the term upstream is used herein to denote a portion of the circuit 10 or the exhaust gas conduits that is reached by the working medium or heating medium before it reaches a particular part of the circuit 10 or the exhaust gas conduits. The third exhaust gas conduit 18 is thus upstream of the heat exchanger 11 since the heating medium flows from the third exhaust gas conduit 18 to the heat exchanger 11.

When the waste heat recovery system 4 is started, the working medium WM is maintained at a first mass flow that is suitable for transferring heat from the heat exchanger 11 to the expansion device 12 but keeping the working medium WM in a liquid state.

The operation of the waste heat recovery system 4 described above, wherein the working medium WM is circulated at a first mass flow through the circuit 10 and passes through the bypass conduit 16 of the expansion device, is referred to herein as a first mode of operation.

After the working medium WM is circulated in the circuit 10 in the first mode of operation, fulfillment of a second condition is detected 103. The second condition is in this embodiment that an expansion device temperature is at a predetermined value, such as an expansion device temperature at a downstream end of the expansion device or a temperature of the working medium at the downstream end of the expansion device. The fulfillment of the second condition is in this embodiment detected by a second sensor S2 that is suitably placed to be able to detect the expansion device temperature.

It is advantageous to place the second sensor S2 at the downstream end of the expansion device 12. One reason is that this allows for the second sensor S2 to determine when sufficient heat has been transferred to the expansion device 12 so that the entire expansion device 12 and not just its upstream part has been heated to reach a desired temperature. Another reason is that a temperature sensitive component, often a sealing, is generally placed in or adjacent to this location so that by detecting a temperature near the sealing it can be ascertained that the temperature has not risen so far as to risk damages to this component. When the working medium WM passes through the bypass conduit 16, more heat is generally transferred to the downstream end of the expansion device 12 than during normal operation when the working medium WM passes through the pistons instead, thereby increasing the risk of damage to sensitive components during start of the waste heat recovery system 4.

When the second condition has been fulfilled, the control unit 24 obtains a signal from a sensor detecting this or alternatively obtains information from another source. In response, the control unit 24 generates at least one signal that changes operation 104 of the waste heat recovery system 4 from the first mode of operation described above to a second mode of operation in which the mass flow of the working medium WM is altered and the bypass conduit 16 is closed so that the working medium WM is transported into the expansion device 12 instead.

The mass flow is thus changed from the first mass flow after the heat exchanger 11 to a second mass flow, and that there is a significant advantage in selecting the second mass flow to be lower than the first mass flow. Lowering the mass flow while maintaining the temperature of the working medium will cause the working medium to vaporize and take the form of superheated steam instead of liquid. The superheated steam will contain sufficient heat to significantly lower the risk of condensation in the expansion device 12, and by combining the change of mass flow with directing the mass flow into the pistons of the expansion device 12, the pistons will be forced into operation to start the expansion device 12. Thus, in the second mode of operation the expansion device 12 is started if sufficient heat has been transferred to it to sufficiently decrease the risk of condensation of the working medium WM.

The change of the mass flow from the first mass flow to the second mass flow can in one embodiment be performed by decreasing the supply of heating medium to the heat exchanger. It may also comprise maintaining a temperature of the working medium in the heat exchanger or downstream of the heat exchanger at a predetermined first temperature. The first temperature is detected and the working medium conveyor operated to adjust the mass flow in order to maintain the first temperature, which when decreasing the supply of heating medium to the heat exchanger will require a decrease of mass flow. This will cause the pressure to change and the superheat is increased. In another embodiment, the mass flow may be changed by changing operation of the working medium conveyor 14 to decrease the flow rate without requiring a feedback control of the temperature, or in other suitable ways such as are well known to the skilled person.

In another embodiment, the second condition may alternatively be a time that has passed since fulfillment of the first condition. This is not detected by a sensor but instead the control unit 24 obtains a signal indicating fulfillment of this condition from another source, such as a processing device that may form part of the control unit 24 itself but could also form part of another unit. To use the time as the second condition is particularly advantageous when the waste heat recovery system 4 is designed to be cost efficient since the second sensor S2 can be avoided altogether. Heating of the expansion device 12 is often predictable when knowing starting conditions of the waste heat recovery system 4 together with properties of the heating medium supplied to the heat exchanger 11, so that a suitable time for keeping the waste heat recovery system 4 in the first mode of operation can be determined with high accuracy.

Performing the steps of the inventive method to operate the waste heat recovery system 4 in a second mode of operation that follows a first mode of operation is in most embodiments sufficient to start the expansion device 12 in the improved way described herein. However, in some situations additional measures may also be taken to further facilitate starting the expansion device. Therefore, the control unit 24 may in such situations be operatively connected to a combustion engine of the motor vehicle and transmit a signal to the combustion engine to request a change of operation of the combustion engine. The change of operation may be a gear shift or a stop and start of the combustion engine that will cause a vibration or mechanical force on the waste heat recovery system 4. This will aid the expansion device 12 in starting a movement of the pistons. In one embodiment, the request for a change of operation of the combustion engine may be transmitted as a response to fulfillment of the second condition, but in other embodiments the request may be sent after the second mode of operation has been initiated. Alternatively, the request may be sent after the waste heat recovery system 4 has been operating at the second mode of operation for a predetermined time if the start of the expansion device 12 has not occurred during that predetermined time.

During the first mode of operation as well as the second mode of operation, it is advantageous to be able to control the supply of heating medium to the heat exchanger. This has the benefits of both being able to determine the amount of heat that is to be transferred to the working medium WM by the heat exchanger and being able to avoid damage due to excessive temperature or excessive flow rate or pressure of the working medium. In this embodiment, a third sensor S3 is provided for detecting the temperature of the working medium in the heat exchanger or downstream of the heat exchanger. A signal corresponding to the detected temperature is transferred to the control unit 24 and the valves 21, 22 can be operated to decrease the amount of heating medium that is supplied to the heat exchanger 11 if the detected temperature is above a predetermined maximum working medium temperature. Thereby, the heat transfer to the working medium WM is controlled and the flow rate or pressure can be lowered.

Alternatively, the third signal S3 can be arranged to detect a heat exchanger temperature, such as a temperature of the working medium WM downstream of the heat exchanger or in the heat exchanger 11, but alternatively instead a temperature of the heat exchanger 11 itself. A signal corresponding to the detected temperature can be transmitted to the control unit 24 and the supply of heating medium to the heat exchanger can be controlled as described above to lower the temperature as desired if the detected temperature is above a predetermined preferred heat exchanger temperature.

To be able to control the heat transfer in the heat exchanger 11 to the working medium WM is advantageous both in more accurately controlling the heat transferred to the expansion device 12 and in ascertaining that damage due to excessive flow rate, pressure or temperature can be avoided.

The interaction of the control unit 24 with components of the waste heat recovery system 4 will now be described with reference to FIG. 4.

The control unit 24 is operatively connected to each of the first sensor S1, second sensor S2 and third sensor S3 if each of said sensors are provided in the system 4 and is thereby able to receive signals from each of said sensors. In response to signals obtained from the sensors S1, S2, S3 and also in response to other signals obtained from the combustion engine, operation of the system 4 is controlled by controlling the bypass valve 17 of the expansion device bypass 25 to select if the working medium WM is to pass through the bypass conduit 16 or the expansion device 12, and also by controlling the first and second valves 21, 22 to determine the supply of heating medium to the heat exchanger 11. Furthermore, the working medium conveyor 14 can be operated by the control unit 24 to control the mass flow, and requests can be sent to an engine control unit 31 of the combustion engine 2 as described above.

The control unit may be a separate unit or distributed into two or more units, and it may comprise one or more of the first, second or third sensors.

In one embodiment, the control unit 24 performs all the functions ascribed to the control unit 24 herein, but in another embodiment the control unit 24 may be distributed in the waste heat recovery system 4 so that some functions and decisions are performed in different parts of the system 4. In yet another embodiment, the control unit 24 may be integrated with another control unit of the vehicle so that a plurality of systems is controlled simultaneously. There may also be a user interface so that input signals can be given manually or by another unit corresponding with the control unit 24, and so that a user can select conditions and receive information regarding the operation or state of the waste heat recovery system 4.

The control unit 24 may thus be implemented as one physical unit or in a distributed manner into two or more physical units. Further, the control unit for the waste heat recovery system 4 may be implemented in one or more other control units for different systems or components of an engine or vehicle in which such an engine and waste heat recovery system 4 is implemented.

Although embodiments of the invention described above with reference to FIG. 1-4 comprise a control unit 24, and processes may be performed in at least one processor of said control unit 24, the invention also extends to computer programs, particularly computer programs on or in a carrier, adapted for putting the invention into practice. The programs may be in the form of source code, object code, a code intermediate source and object code such as in partially compiled form, comprise software or firmware, or in any other form suitable for use in the implementation of the process according to the invention. The program may either be a part of an operating system, or be a separate application. The carrier may be any entity or device capable of carrying the program. For example, the carrier may comprise a storage medium, such as a Flash memory, a ROM (Read Only Memory), for example a DVD (Digital Video/Versatile Disk), a CD (Compact Disc) or a semiconductor ROM, an EPROM (Erasable Programmable Read-Only Memory), an EEPROM (Electrically Erasable Programmable Read-only Memory), or a magnetic recording medium, for example a floppy disc or hard disc. Further, the carrier may be a transmissible carrier such as an electrical or optical signal which may be conveyed via electrical or optical cable or by radio or by other means. When the program is embodied in a signal which may be conveyed directly by a cable or other device or means, the carrier may be constituted by such cable or device or means. Alternatively, the carrier may be an integrated circuit in which the program is embedded, the integrated circuit being adapted for performing, or for use in the performance of, the relevant processes.

In one or more embodiments, there may be provided a computer program loadable into a memory communicatively connected or coupled to at least one data processor, e.g. the control unit 24, comprising software or hardware for executing the method according any of the embodiments herein when the program is run on the at least one data processor.

In one or more further embodiment, there may be provided a processor-readable medium, having a program recorded thereon, where the program is to make at least one data processor, e.g. the control unit 24, execute the method according to of any of the embodiments herein when the program is loaded into the at least one data processor.

It is to be noted that features from the various embodiments described herein may freely be combined, unless it is explicitly stated that such a combination would be unsuitable. It is also to be noted that features mentioned with regard to a specific embodiment may be optional with regard to other embodiments. In particular, the combination of first and second conditions for any given embodiment may be selected freely depending on what is desired for a particular application.

1. A method for starting an expansion device of a waste heat recovery system in a combustion engine, wherein the waste heat recovery system comprises a heat exchanger, an expansion device, a condenser and a working medium conveyor configured to circulate a working medium, the method comprising:
circulating a working medium in the waste heat recovery system in response to a first condition being fulfilled, wherein the working medium is at a first mass flow downstream of the heat exchanger and wherein the working medium is circulated through a bypass conduit in the expansion device; and
in response to a second condition being fulfilled changing the mass flow of the working medium to a second mass flow downstream of the heat exchanger and redirecting the working medium from the bypass conduit to pass through the expansion device for starting the expansion device, wherein the second mass flow is lower than the first mass flow.

2. The method according to claim 1, wherein the first condition is a start of a combustion engine of the vehicle.

3. The method according to claim 1, wherein the first condition is a heat exchanger temperature, measure either as a temperature of the heating medium in the heat exchanger or a temperature of the heating medium upstream of the heat exchanger.

4. The method according to claim 1, wherein the second condition is an expansion device temperature, that may be one or more of an expansion device temperature at a downstream end of the expansion device and a temperature of the working medium at the downstream end of the expansion device.

5. The method according to claim 1, wherein the second condition is a time that has passed since fulfillment of the first condition.

6. The method according to claim 1, wherein the mass flow of the working medium is changed from the first mass flow to the second mass flow by decreasing a supply of heating medium to the heat exchanger and maintaining a temperature of the working medium in the heat exchanger or downstream of the heat exchanger at a predetermined first temperature by decreasing the mass flow of the working medium.

7. The method according to claim 1, further comprising decreasing a supply of heating medium to the heat exchanger in response to a mass flow of the working medium downstream of the heat exchanger being above a predetermined maximum working medium mass flow and/or in response to a heat exchanger temperature being above a predetermined preferred heat exchanger temperature, wherein said heat exchanger temperature may be a temperature of the working medium in the heat exchanger or downstream of the heat exchanger.

8. The method according to claim 1, further comprising requesting a change of operation of a combustion engine after fulfillment of the second condition, wherein said change of operation may be a gear shift or a stop and start of the combustion engine.

9. A control unit for a waste heat recovery system for a combustion engine, the waste heat recovery system having a heat exchanger, an expansion device, a condenser and a working medium conveyor for circulating a working medium in the system, wherein the control unit is configured to:
obtain a signal corresponding to a first condition being fulfilled and to generate at least one signal for operating the working medium conveyor and an expansion device bypass in a first mode of operation; and
obtain a signal corresponding to fulfillment of a second condition and to generate at least one signal for operating the working medium conveyor and the expansion device bypass in a second mode of operation.

10. A control unit according to claim 9,
wherein the at least one signal for operating the working medium conveyor and the expansion device bypass in the first mode of operation generated by the control unit comprises a signal for the working medium conveyor to circulate the working medium and to maintain the working medium at a first mass flow downstream of the heat exchanger, and also comprises a signal for the expansion device bypass to direct the working medium through a bypass conduit at the expansion device,
wherein the at least one signal for operating the working medium conveyor and the expansion device bypass in the second mode of operation generated by the control unit comprises a signal for the working medium conveyor to maintain the working medium at a second mass flow downstream of the heat exchanger, wherein the second mass flow is lower than the first mass flow, and also comprises a signal for the expansion device bypass to direct the working medium through the expansion device for starting the expansion device.

11. A control unit according to claim 9, wherein the control unit is further configured to obtain a signal corresponding to a heat exchanger temperature, such as a temperature of the working medium in the heat exchanger or downstream of the heat exchanger, or a working medium mass flow downstream of the heat exchanger and to generate a signal for operating a heat exchanger bypass control to limit a supply of heating medium if a detected heat exchanger temperature is above a predetermined preferred heat exchanger temperature, or if a detected working medium mass flow is above a predetermined maximum working medium mass flow.

12. A control unit according to claim 9, wherein the control unit is further configured to request a change of operation of a combustion engine after obtaining a signal corresponding to the second condition being fulfilled, wherein said change of operation may be a gear shift or a stop and start of the combustion engine.

13. A waste heat recovery system for a combustion engine, comprising:
a heat exchanger;
an expansion device;
a condenser;
a working medium conveyor for circulating a working medium in the system; and
a control unit configured to:
obtain a signal corresponding to a first condition being fulfilled and to generate at least one signal for operating the working medium conveyor and an expansion device bypass in a first mode of operation; and
obtain a signal corresponding to fulfillment of a second condition and to generate at least one signal for operating the working medium conveyor and the expansion device bypass in a second mode of operation.

14. The waste heat recovery system according to claim 13, comprising a first sensor for detecting fulfillment of the first condition, the first sensor being operatively connected to the control unit and optionally also comprising a second sensor for detecting fulfillment of the second condition, the second sensor being operatively connected to the control unit.

15. The waste heat recovery system according to claim 13, further comprising an expansion device bypass having a bypass valve for controlling a mass flow of working medium either into a bypass conduit or into at least one piston of the expansion device.

16. The waste heat recovery system according to claim 14, wherein the first sensor is configured to detect a start of a combustion engine of the vehicle as fulfillment of the first condition.

17. The waste heat recovery system according to claim 14, wherein the first sensor is configured to detect a heat exchanger temperature as fulfillment of the first condition, wherein said heat exchanger temperature may be a temperature of a heating medium in the heat exchanger or a temperature of a heating medium upstream of the heat exchanger.

18. The waste heat recovery system according to claim 14, wherein the second sensor is configured to detect an expansion device temperature as fulfillment of the second condition, and wherein said expansion device temperature may be a temperature of the working medium at the expansion device or a temperature of the working medium at a downstream end of the expansion device or downstream of the expansion device.

19. The waste heat recovery system according to claim 14, wherein the second sensor is configured to detect as fulfillment of the second condition a time that has passed since the first sensor detected fulfillment of the first condition.

20. The waste heat control system according to claim 13, further comprising a third sensor for detecting a heat exchanger temperature, from either a temperature of the working medium in the heat exchanger or downstream of the heat exchanger, or a working medium mass flow downstream of the heat exchanger.

21. The waste heat recovery system according to claim 13, wherein at least one of the first sensor, second sensor or third sensor is integrated with the control unit and/or with each other.

22. The waste heat recovery system according to claim 13, wherein the bypass conduit at the expansion device is arranged to transfer heat from the working medium in the bypass conduit to at least a part of the expansion device for heating the expansion device during the first mode of operation.

23. (canceled)

24. A computer program product comprising computer program code stored on a non-transitory computer-readable medium, said computer program product used for starting an expansion device of a waste heat recovery system in a combustion engine, wherein the waste heat recovery system comprises a heat exchanger, an expansion device, a condenser and a working medium conveyor configured to circulate a working medium, said computer program code comprising computer instructions to cause one or more control units to perform the following operations:
obtain a signal corresponding to a first condition being fulfilled and to generate at least one signal for operating the working medium conveyor and an expansion device bypass in a first mode of operation; and
obtain a signal corresponding to fulfillment of a second condition and to generate at least one signal for operating the working medium conveyor and the expansion device bypass in a second mode of operation.

25. (canceled)

26. A vehicle comprising a waste heat recovery system for a combustion engine, said waste heat recovery system comprising:
a heat exchanger;
an expansion device;
a condenser;
a working medium conveyor for circulating a working medium in the system; and
a control unit configured to:
obtain a signal corresponding to a first condition being fulfilled and to generate at least one signal for operating the working medium conveyor and an expansion device bypass in a first mode of operation; and
obtain a signal corresponding to fulfillment of a second condition and to generate at least one signal for operating the working medium conveyor and the expansion device bypass in a second mode of operation.
